(19) United States
(12) Patent Application Publication
(10) Pub. No.: US 2011/0302732 A1
(43) Pub. Date: Dec. 15, 2011

(54) DUAL-CONNECTION RUBBER BALL FOR CLEANING AND DESCALING IN A HEAT EXCHANGE TUBE

(75) Inventor: Ji'an Meng, Beijing (CN)

(73) Assignee: TSINGHUA UNIVERSITY, Beijing (CN)

(21) Appl. No.: 13/154,526

(22) Filed: Jun. 7, 2011

(30) Foreign Application Priority Data
Jun. 10, 2010 (CN) 201010196781.8

(51) Int. Cl. B08B 9/023

(52) U.S. Cl. 15/104.04

(57) ABSTRACT

A dual-connection rubber ball for cleaning and descaling in a heat exchange tube, which belongs to the field of cleaning and descaling in the heat exchange tube includes two solid rotatable bodies, elastic cleaning and descaling fins and an intermediate elastic connecting body, the elastic cleaning and descaling fins are disposed uniformly in the circumferential direction of the two solid rotatable bodies, the intermediate elastic connecting body is connected to the two solid rotatable bodies respectively at it two ends, the thickness of the fin is 0.6-2 mm, the ratio of height to thickness of the fin is 1.25-4, the intermediate elastic connecting body can be formed as a cylinder shaped body, a sheet shaped body or a compound body thereof, the diameter of the cylinder shaped intermediate elastic connecting body is 1/10 to ½ of the inner diameter of the heat exchange tube. The thickness of the sheet shaped intermediate elastic connecting body is 1/25 to ⅕ of the inner diameter of the heat exchange tube. The difference between the density of the conveyer fluid and the density of the solid rotatable body is not more than 8%. The present invention has the advantages of being effective in cleaning and descaling, less likely to block the heat exchange tube, and having a long service life.

### RELATED APPLICATION DATA

This application claims priority from Chinese Patent Application No. 201010196781.8, filed Jun. 10, 2010.

### BACKGROUND

The present invention relates to a dual-connection rubber ball for cleaning and descaling in a heat exchange tube, especially a dual-connection rubber ball for cleaning and descaling in a heat exchange tube in which two rubber balls are connected into an integral piece by an intermediate elastic connecting body.

Shell and tube heat exchanger is applied largely and widely in the industrial fields of electric power, chemical engineering, petroleum and the like. There is a common phenomenon of dirt retention and scaling in most the heat exchangers in operation, especially in the condenser, the water cooler and the like, which employ circulating water for cooling. The dirt retention and scaling of the heat exchanger lead to a reduction of the coefficient of heat transfer, an increase of energy consumption, and even to the failure of normal operation since the tube is blocked.

The scaling may also lead to an under scale corrosion, and thus shorten the service life of the heat exchanger. Currently, there are two modes of cleaning and descaling in the tube of the shell and tube heat exchanger, i.e., the online mode and the offline mode. The online mode of cleaning and descaling has unique advantages without affecting the normal production. The online rubber ball cleaning technology is currently widely applied in the condenser of the power plant. However, since the common rubber ball currently used has a structure of microporous flexible elastomer, the diameter and the specific gravity of the rubber ball in a wetted state can hardly be exactly controlled during use, and it is prone to be adhered by sludge, dirt, microbe and the like, which may lead to some problems of insufficient cleaning and descaling, a low ball collecting rate and a high possibility of blocking the tube and the like.

### SUMMARY

In view of the above problems, it is an object of the invention to provide a dual-connection rubber ball for cleaning and descaling in a heat exchange tube, which is less likely to block the tube and has a good effect of cleaning and descaling.

To achieve the above object, the following technical solutions are provided by the invention:

A dual-connection rubber ball for cleaning and descaling in a heat exchange tube includes two solid rotatable bodies, elastic cleaning and descaling fins and an intermediate elastic connecting body, wherein

the elastic cleaning and descaling fins are disposed circumferentially on each of the solid rotatable bodies,

the two solid rotatable bodies are connected into an integral piece by the intermediate elastic connecting body.

Preferably, the elastic cleaning and descaling fins are disposed circumferentially and uniformly on each of the solid rotatable bodies.

Preferably, the solid rotatable body is anyone of a cylinder-shaped body, a sphere-shaped body, a partial sphere-shaped body and a truncated cone-shaped body.

Preferably, the elastic cleaning and descaling fin can be anyone of a spiral fin, a inclined fin and an circumferentially discontinuous fin.

Preferably, the intermediate elastic connecting body can be a cylinder-shaped body, a sheet-shaped body or a compound body thereof.

Preferably, in the case that the intermediate elastic connecting body is a cylinder-shaped body, the diameter of the cylinder-shaped body is 1/10 to ½ of the inner diameter of the heat exchange tube to be cleaned.

Preferably, in the case that the intermediate elastic connecting body is a sheet-shaped body, the thickness of the sheet-shaped body is 1/25 to ⅕ of the inner diameter of the heat exchange tube to be cleaned.

Preferably, the thickness of the elastic cleaning and descaling fin is in a range of 0.6-2 mm, and the ratio of height to thickness of the elastic cleaning and descaling fin is in a range of 1.25-4.

Preferably, the outer enveloping surface of the elastic cleaning and descaling fin has a shape of anyone of a cylinder, a sphere, a partial sphere and a truncated cone.

Preferably, the difference between the density of the conveyer fluid and the density of the solid rotatable body is not more than 8%.

By the technical solutions as described above, the invention has the advantages of being effective in cleaning and descaling, less likely to block the heat exchange tube, and having a long service life.

### BRIEF DESCRIPTION OF THE DRAWINGS

FIG. 1 is a (two dimensional) structural schematic view according to the first embodiment of the present invention;

FIG. 2 is a (three dimensional) structural schematic view according to the first embodiment of the present invention;

FIG. 3 is a structural schematic view observed in the direction indicated by arrow A according to the first embodiment of the present invention;

FIG. 4 is a sectional structural schematic view taken along a line B-B according to the first embodiment of the present invention;

FIG. 5 is a structural schematic view according the second embodiment of the present invention;

FIG. 6 is a middle sectional structural schematic view according to the second embodiment of the present invention;

FIG. 7 is a structural schematic view according to the third embodiment of the present invention;

FIG. 8 is a middle sectional structural schematic view according to the third embodiment of the present invention;

FIG. 9 is a structural schematic view according to the fourth embodiment of the present invention;

FIG. 10 is a structural schematic view according to the fifth embodiment of the present invention; and

FIG. 11 is a structural schematic view according to the sixth embodiment of the present invention.

### DETAILED DESCRIPTION

The present invention will now be described in detailed with reference to the accompanying drawings and the preferred embodiments.

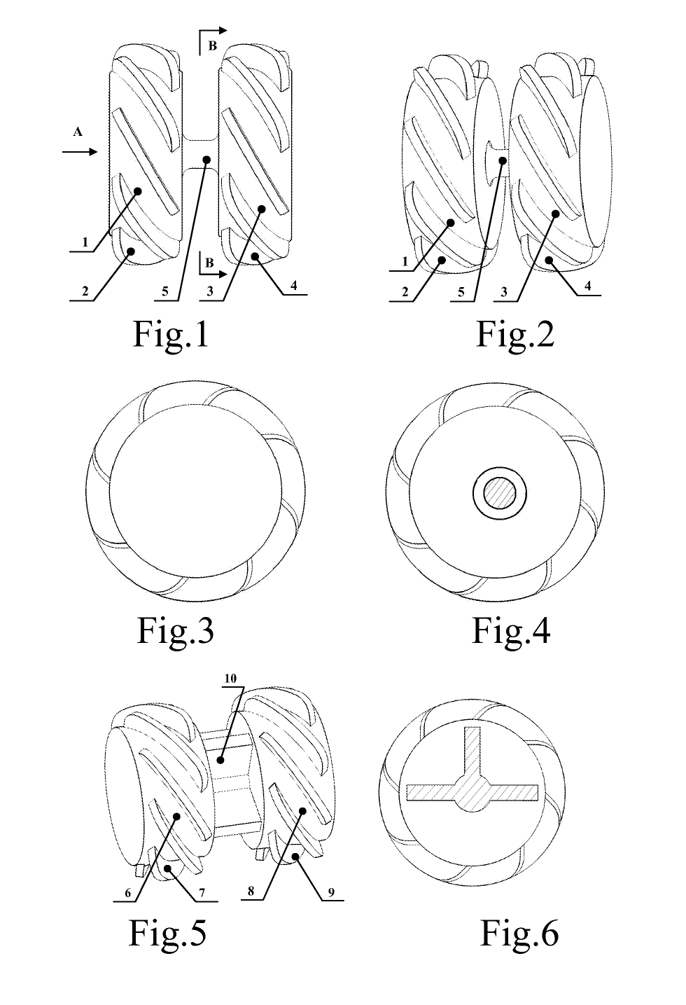

The first embodiment: FIG. 1 is a two-dimensional structural schematic view according to the first embodiment of the present invention. FIG. 2 is a three-dimensional structural schematic view according to the first embodiment of the present invention. FIG. 3 is a structural schematic view observed in the direction indicated by arrow A in FIG. 1 according to the first embodiment of the present invention. FIG. 4 is a sectional structural schematic view taken along a line B-B in FIG. 1 according to the first embodiment of the present invention.

As shown in FIGS. 1 and 2, the present embodiment comprises a solid cylinder-shaped body 1, eight inclined fins 2 on the solid cylinder-shaped body 1, a solid cylinder-shaped body 3, eight inclined fins 4 on the solid cylinder-shaped body 3, and an intermediate elastic connecting cylinder-shaped body 5. In this embodiment, a rubber ball for cleaning and descaling is composed of the solid cylinder-shaped body 1 and the eight inclined fins 2, and a further rubber ball for cleaning and descaling is composed of the solid cylinder-shaped body 3 and the eight inclined fins 4. Then the two rubber balls for cleaning and descaling are connected into an integral piece by the intermediate elastic connecting cylinder-shaped body 5, that is, a dual-connection rubber ball for cleaning and descaling in a heat exchange tube is formed. The outer enveloping surface of the inclined fin is a cylindrical surface.

In this embodiment, the dual-connection rubber ball is made of rubber composite material, and its density is close to the density of the conveyer fluid. The difference between the density of the rubber composite material and the density of the conveyer fluid is ±5%, and generally is not more than 8%. In order to assure the reliability of the connection between the intermediate elastic connecting body and the two rubber balls for cleaning and descaling on its two ends, the connecting portions between them are formed as smooth transition portions. In order to obtain a good machinability of the dual-connection rubber ball, the edges and the corners of the dual-connection rubber ball can be rounded and the fins are arranged at a certain inclination angle. For the simplicity of the drawings, the rounds and the inclination angle are not marked in the drawings of the embodiment. The heat exchange tube according to this embodiment has an inner diameter of 23.6-24 mm. The solid cylinder-shaped body has a diameter of 19.4 mm. The outer profile of the inclined fin has a diameter of 24.4 mm. The intermediate elastic connecting cylinder-shaped body has a diameter of 4 mm. The inclined fin has a thickness of 0.8-1.25 mm and a height of 2.5 mm. The ratio of height to thickness of the inclined fin is 2-3.2. The dual-connection rubber ball has a total length of 22 mm. The intermediate elastic connecting cylinder-shaped body has a length of 4 mm.

The minimum diameter of the intermediate elastic connecting cylinder-shaped body is generally not more than half of the inner diameter of the heat exchange tube to be cleaned, and the material used is rubber composite material. Therefore, it has a good elasticity and can be easily compressed, bent and the like, so it is called as an intermediate elastic connecting body. In the case that the dual-connection rubber ball for cleaning and descaling lies across the end of the heat exchange tube, since the good elasticity of the intermediate elastic connecting body and the outer fins, under the pressure differential force of the fluid, the transversely positioned state can be easily changed and adjusted to a state that the rotation axis is approximately be parallel to the axis of the heat exchange tube or coincided with it, so that a self rotation and a forward movement along with the fluid are formed and thus an effect of cleaning and the descaling is obtained. Thus, the dual-connection rubber ball for cleaning and descaling in a heat exchange tube according to the embodiment has the advantage of without blocking the heat exchange tube. In the process of passing the heat exchange tube in one time, since it can scrape and scour the inner wall of the heat exchange tube several times, the dual-connection rubber ball will have a better effect of cleaning and descaling.

The second embodiment: As shown in FIG. 5, the present embodiment comprises a solid cylinder-shaped body 6, eight inclined fins 7 on the solid cylinder-shaped body 6, a solid cylinder-shaped body 8, eight inclined fins 9 on the solid cylinder-shaped body 8, and an intermediate elastic connecting compound body 10 composed of an intermediate connecting cylinder-shaped body and an intermediate connecting sheet-shaped body. In this embodiment, a rubber ball for cleaning and descaling is composed of the cylinder-shaped body 6 and the eight inclined fins 7, and a further rubber ball for cleaning and descaling is composed of the cylinder-shaped body 8 and the eight inclined fins 9. The two rubber balls for cleaning and descaling are connected into one piece by the intermediate elastic connecting compound body 10, so as to form a dual-connection rubber ball for cleaning and descaling in the heat exchange tube. The intermediate elastic connecting compound body 10 is composed of one intermediate connecting cylinder-shaped body and three intermediate connecting sheet-shaped bodies, wherein the three intermediate connecting sheet-shaped bodies are arranged in a T-shape manner. FIG. 6 is a middle sectional structural schematic view of the present embodiment as shown in FIG. 5. The outer enveloping surface of the inclined fin is a cylindrical surface.

The heat exchange tube according to this embodiment has an inner diameter of 23.6-24 mm. The solid cylinder-shaped body has a diameter of 19 mm. The outer profile of the fin has a diameter of 24 mm. The intermediate connecting cylinder-shaped body has a diameter of 6 mm. The intermediate connecting sheet-shaped body has a thickness of 2 mm. The inclined fin has a thickness of 1-1.5 mm, and a height of 2.5 mm. The ratio of height to thickness of the inclined fin is 1.7-2.5. The total length of the dual-connection rubber ball is 27 mm. The length of the intermediate elastic connecting compound body is 7 mm.

The intermediate elastic connecting body in this embodiment is a compound body composed of a cylinder-shaped body and a sheet-shaped body. Its rigidity is much greater than that of the first embodiment, so the total length of the dual-connection rubber ball thus designed is greater than the inner diameter of the heat exchange tube, so that the dual-connection rubber ball will not be transversely positioned at the end of the heat exchange tube. According to this embodiment, the length of the intermediate connecting cylinder-shaped body is slightly smaller than that of the tube bridge (the length of the tube bridge according to this embodiment is about 8 mm), and taking into account of the asymmetry and fluctuation of the force of the fluid applied to the dual-connection rubber ball at the ends of the heat exchange tube, the dual-connection rubber ball will not be transversely positioned between two heat exchange tubes at the end of the heat exchange tube.

This embodiment differs from the first embodiment in that: the intermediate elastic connecting body in the first embodiment is a cylinder-shaped body, whereas the intermediate elastic connecting body in the second embodiment is a compound body of a cylinder-shaped body and a sheet-shaped body, both the total length of the dual-connection rubber body and the length of the intermediate elastic connecting body in this embodiment are greater than the corresponding lengths in the first embodiment. According to the second embodiment, it is easier to adjust the direction of the dual-connection rubber ball at the ends of the heat exchange tube so as to enter into the heat exchange tube.

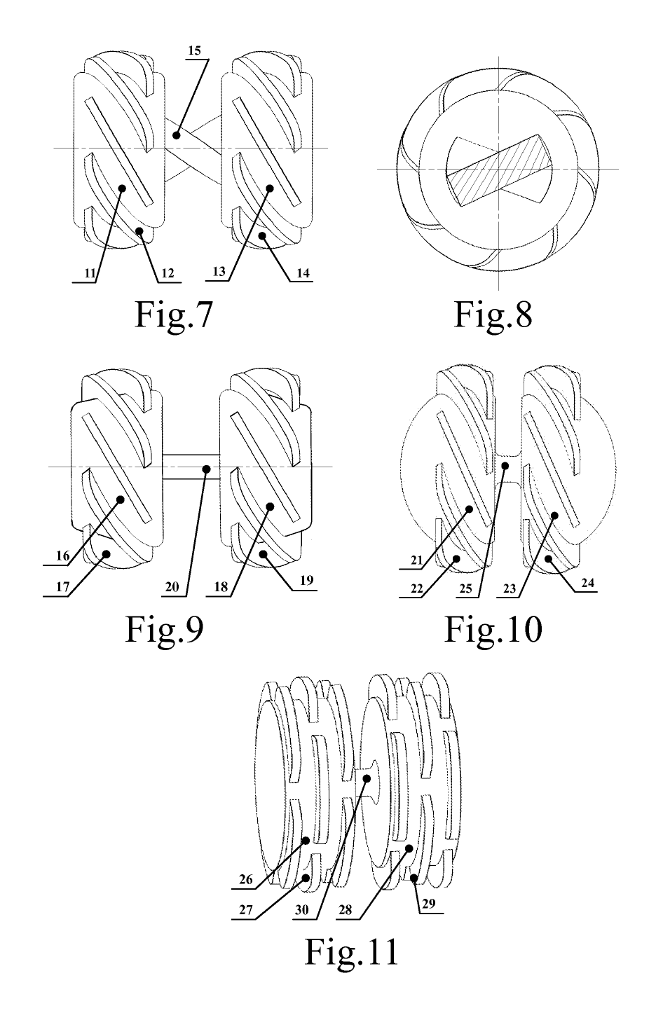

The third embodiment: As shown in FIG. 7, this embodiment comprises a solid cylinder-shaped body 11, eight inclined fins 12 on the solid cylinder-shaped body 11, a solid cylinder-shaped body 13, eight inclined fins 14 on the solid cylinder-shaped body 13, and an intermediate elastic connecting twisted sheet-shaped body 15. In this embodiment, a rubber ball for cleaning and descaling is composed of the cylinder-shaped body 11 and the eight inclined fins 12. A further rubber ball for cleaning and descaling is composed of the cylinder-shaped body 13 and the eight inclined fins 14. The two rubber balls for cleaning and descaling are connected into an integral piece by the intermediate elastic connecting twisted sheet-shaped body 15, so as to form a dual-connection rubber ball for cleaning and descaling in the heat exchange tube. FIG. 8 is a middle sectional structural schematic view of the present embodiment as shown in FIG. 7. The outer enveloping surface of the inclined fin is a cylindrical surface.

This embodiment differs from the first embodiment in that: the intermediate elastic connecting body in the first embodiment is a cylinder-shaped body, whereas the intermediate elastic connecting body in the third embodiment is a twisted sheet-shaped body. According to the third embodiment, it is easier to adjust the direction of the dual-connection rubber ball at the ends of the heat exchange tube so as to enter into the heat exchange tube.

The fourth embodiment: As shown in FIG. 9, this embodiment comprises a solid truncated cone-shaped body 16, eight inclined fins 17 on the solid truncated cone-shaped body 16, a solid truncated cone-shaped body 18, eight inclined fin 19 on the solid truncated cone-shaped body 18, and an intermediate elastic connecting sheet-shaped body 20. In this embodiment, a rubber ball for cleaning and descaling is composed of the solid truncated cone-shaped body 16 and the eight inclined fins 17. A further rubber ball for cleaning and descaling is composed of the truncated cone-shaped body 18 and the eight inclined fins 19. The two rubber balls for cleaning and descaling are connected into an integral piece by the intermediate elastic connecting sheet-shaped body 20, so as to form a dual-connection rubber ball for cleaning and descaling in the heat exchange tube. The outer enveloping surface of the inclined fin is a truncated cone-shaped surface.

This embodiment differs from the first embodiment in that: each of the solid rotatable bodies of the two rubber balls is a cylinder-shaped body in the first embodiment; whereas each of the solid rotatable bodies of the two rubber balls in the fourth embodiment is a truncated cone-shaped body. According to the fourth embodiment, it is easier to adjust the direction of the dual-connection rubber ball at the ends of the heat exchange tube so as to enter into the heat exchange tube.

The fifth embodiment: As shown in FIG. 10, this embodiment comprises a solid partial sphere-shaped body 21, ten inclined fins 22 on the solid partial sphere-shaped body 21, a solid partial sphere-shaped body 23, ten inclined fins 24 on the solid partial sphere-shaped body 23, and an intermediate elastic connecting cylinder-shaped body 25. In this embodiment, a rubber ball for cleaning and descaling is composed of the partial sphere-shaped body 21 and the ten inclined fins 22. Another rubber ball for cleaning and descaling is composed of the partial sphere-shaped body 23 and the ten inclined fins 24. The two rubber balls for cleaning and descaling are connected into an integral piece by the intermediate elastic connecting cylinder-shaped body 25, so as to form a dual-connection rubber ball for cleaning and descaling in the heat exchange tube. The outer enveloping surface of the inclined fin is a partial spherical surface.

This embodiment differs from the first embodiment in that: each of the solid rotatable bodies of the two rubber balls in the first embodiment is a cylinder-shaped body, whereas each of the solid rotatable bodies of the two rubber balls in the fifth embodiment is a portion of a sphere-shaped body. According to the fifth embodiment, it is easier to adjust the direction of the dual-connection rubber ball at the ends of the heat exchange tube so as to enter into the heat exchange tube, whereas according to the first embodiment, more material can be saved.

The sixth embodiment: As shown in FIG. 11, this embodiment comprises a solid cylinder-shaped body 26, twelve lateral fins 27 dispersed circumferentially on the solid cylinder-shaped body 26, a solid cylinder-shaped body 28, twelve lateral fins 29 dispersed circumferentially on the solid cylinder-shaped body 28, and an intermediate elastic connecting cylinder-shaped body 30. In this embodiment, a rubber ball for cleaning and descaling is composed of the cylinder-shaped body 26 and the twelve lateral fins 27 dispersed circumferentially. A further rubber ball for cleaning and descaling is composed of the cylinder-shaped body 28 and the twelve lateral fins 29 dispersed circumferentially. The two rubber balls for cleaning and descaling are connected into an integral piece by the intermediate elastic connecting cylinder-shaped body 30, so as to form a dual-connection rubber ball for cleaning and descaling in the heat exchange tube. The outer enveloping surface of the inclined fins is a cylindrical surface.

This embodiment differs from the first embodiment in that: the fins in the first embodiment are inclined fins disposed circumferentially and uniformly, whereas the fins in the sixth embodiment are lateral fins dispersed circumferentially; it could produce a rotation in the first embodiment so that the heat exchange tube is less likely to be blocked, whereas the pressure differential force is relatively larger in the sixth embodiment, and it could obtain a good effect of cleaning and descaling even under a smaller flow rate. The fins disposed outside of the solid rotatable body of the rubber ball may be inclined fins, discontinuous circumferential fins or spiral fins. The inclined fins and the discontinuous circumferential fins are much easier to be manufactured, whereas the spiral fins give a better motion characteristic of the rubber ball.

The solid rotatable body of the rubber ball according to the present invention can be anyone of a cylinder-shaped body, a sphere-shaped body, a partial sphere-shaped body and a truncated cone-shaped body.

The intermediate elastic connecting body of the rubber ball according to the present invention can be anyone of a cylinder-shaped body, a sheet-shaped body (including a twisted sheet-shaped body), a compound body of a cylinder-shaped body and a sheet-shaped body.

The thickness of the fin disposed circumferentially of the rubber ball according to the present invention is in a range of 0.6-2 mm. The ratio of height to thickness of the fin is in a range of 1.25-4. Too thin fin may lead to a shorter service life and the difficulty of manufacture. Too thick fin may lead to insufficient elasticity, and thus the heat exchange tube may be blocked. Smaller ratio of height to thickness of the fin may lead to insufficient elasticity and thus the heat exchange tube may be blocked, whereas larger ratio of height to thickness of the fin may lead to the difficulty of manufacture and poor cleaning effect.

The minimum diameter of the intermediate elastic connecting cylinder-shaped body of the rubber ball according to the present invention is not more than ½ of the inner diameter of the heat exchange tube to be cleaned. The minimum thickness of the intermediate elastic connecting sheet-shaped body of the rubber ball is not more than ⅕ of the inner diameter of the heat exchange tube to be cleaned. Suitable minimum diameter or thickness of the intermediate elastic connecting body will give the rubber ball a good deformation characteristic and thus the heat exchange tube will not be blocked, while its service life can be assured. Generally the minimum diameter of the intermediate elastic connecting cylinder-shaped body is in a range of 1/10 to ½ of the inner diameter of the heat exchange tube to be cleaned, and the minimum thickness of the intermediate elastic connecting sheet-shaped body is in a range of 1/25 to ⅕ of the heat exchange tube to be cleaned.

The solid rotatable body of the rubber ball according to the present invention has a compact solid structure and the difference between its density and the density of the conveyer fluid is proposed to be within 5%, generally is not more than 8%. The compact solid structure, instead of a microporous or hollow structure, will provide a size and a density with better stability and controllability. The difference between the density of the rubber ball and the density of the conveyer fluid is controlled to be within a suitable range, which ensures that it has a good following characteristic, so that it has a better cleaning and descaling effect as well as a high ball collecting rate.

The dual-connection rubber ball of the invention can be manufactured from a variety of ways. For example, the dual-connection rubber ball can be integrally formed by an overall molding process. Alternatively, the solid rotatable bodies and the intermediate elastic connecting body can be integrally formed firstly, and then the elastic cleaning and descaling fins are machined or connected on the solid rotatable bodies.

The invention has been described in details herein in conjunction with preferred embodiments. Obviously, the above description and the embodiments as shown in the drawings should only be interpreted as illustrative, and should not be construed as limitations on the scope of the invention. It can be easily understood for those skilled in the art that many variations or modifications can be made without departing from the principle and spirit of the invention. For example, the number, the arrangement and the inclined angle of the fins can be adjusted based on the actual requirements, two or more intermediate elastic connecting bodies can be used, and the structure and shape of the intermediate elastic connecting body can be varied, etc. All these variations or modifications fall within the scope of the invention.

What is claimed is:

1. A dual-connection rubber ball for cleaning and descaling in the heat exchange tube comprising: two solid rotatable bodies, elastic cleaning and descaling fins and an intermediate elastic connecting body, wherein
the elastic cleaning and descaling fins are disposed circumferentially on each of the solid rotatable bodies,
the two solid rotatable bodies are connected into an integer piece by the intermediate elastic connecting body.

2. The dual-connection rubber ball according to claim 1, wherein the elastic cleaning and descaling fins are disposed circumferentially and uniformly on each of the solid rotatable bodies.

3. The dual-connection rubber ball according to claim 1, wherein the solid rotatable body is anyone of a cylinder-shaped body, a sphere-shaped body, a partial sphere-shaped body and a truncated cone-shaped body.

4. The dual-connection rubber ball according to claim 1, wherein the elastic cleaning and descaling fin is anyone of a spiral fin, an inclined fin and a circumferentially discontinuous fin.

5. The dual-connection rubber ball according to claim 4, wherein the thickness of the elastic cleaning and descaling fin is in a range of 0.6-2 mm, the ratio of height to thickness of the elastic cleaning and descaling fin is in a range of 1.25-4.

6. The dual-connection rubber ball according to claim 1, wherein the intermediate elastic connecting body is a cylinder-shaped body, a sheet-shaped body or a compound body thereof.

7. The dual-connection rubber ball according to claim 6, wherein in the case that the intermediate elastic connecting body is a sheet-shaped body, the thickness of the sheet-shaped body is 1/25 to ⅕ of the inner diameter of the heat exchange tube to be cleaned.

8. The dual-connection rubber ball according to claim 1, wherein in the case that the intermediate elastic connecting body is a cylinder-shaped body, the diameter of the cylinder-shaped body is 1/10 to ½ of the inner diameter of the heat exchange tube to be cleaned.

9. The dual-connection rubber ball according to claim 1, wherein the outer enveloping surface of the elastic cleaning and descaling fin has a shape of anyone of a cylinder, a sphere, a partial sphere and a truncated cone.

10. The dual-connection rubber ball according to claim 1, wherein the difference between the density of the conveyer fluid and the density of the solid rotatable body is not more than 8%.
